(19) United States
(12) Patent Application Publication
(10) Pub. No.: US 2005/0232731 A1
(43) Pub. Date: Oct. 20, 2005

(54) Dispensing system

(76) Inventor: Virgil D. Lund, Eden Prairie, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/106,786

(22) Filed: Apr. 15, 2005

Related U.S. Application Data
(60) Provisional application No. 60/563,173, filed on Apr. 16, 2004.
(60) Provisional application No. 60/565,615, filed on Apr. 27, 2004.

(51) Int. Cl. B65G 53/40

(52) U.S. Cl. 414/288

(57) ABSTRACT

A sealable container and a dispenser suitable for use with the sealable container are disclosed. The sealable container comprises a plurality of generally tapering sides and a sealable structure disposed at each end of the container. The dispenser includes a hopper and an opening assembly. The hopper is configured for a contacting substantially parallel relation with the generally tapering sides of the sealable container, when the sealable container is disposed in the hopper. The opening assembly includes an opener, which punctures, then withdraws from, the sealable structure.

This invention claims priority to U.S. Provisional Application No. 60/563,173, filed 16 Apr. 2004 and having Attorney Docket Number 2476.08US01 and well as U.S. Provisional Application No. 60/565,615, filed 27 Apr. 2004 and having Attorney Docket Number 2476.10US01. Said Provisional Applications in their entirety are incorporated herein by reference.

### FIELD OF THE INVENTION

This invention relates to dispensing systems and methods, in particular, this invention relates to dispensing devices having mechanical openers for opening sealed containers containing dry flowable material and methods utilizing such.

### BACKGROUND OF THE INVENTION

Dry, flowable materials are frequently stored, transported, and dispensed from containers. In industries, such as the seed treatment industry, these materials may be hazardous to workers or the environment. Hence the containers used should be sealable to prevent personnel or the environment from being exposed to these materials. Often there is dust associated with such material that can be released when the containers are opened. When being used, the materials must often be transferred from the containers, thereby exposing workers in the environment to these materials. These materials may be blended with other ingredients to form substances such as slurries or blends with other dry materials. Such slurries and blends are used to treat seeds with pesticides, e.g., insecticides, fungicides, nematicides, plant growth regulators, herbicide safeners, bactericides, and the like. When empty, the containers must be properly disposed of to avoid contaminating the environment. While some containers of hazardous substances can be attached to dispensing equipment, the containers must often be opened before being attached thereto. Opening containers potentially exposes personnel to the hazardous materials disposed therein and also provides the potential for exposure to the environment to spillage of the contents.

There is then a need for a sealable container for storing, transporting, and dispensing materials stored therein. There is a particular need for a dispenser safely and efficiently dispensing materials from a sealable container, which includes an opening assembly, the opening assembly safely opening the sealed container when operably disposed in the dispenser so as to eliminate, or greatly reduce the risk of, exposure of personnel and the environment to potentially hazardous contents.

### SUMMARY OF THE INVENTION

This invention substantially meets the aforementioned needs of the industry by providing a sealable or sealed container of flowable, solid material and a dispenser. The instant sealable container, when sealed, safely and efficiently stores, transports, and, in combination with the dispenser, dispenses potentially hazardous materials. In preferred embodiments, the sides of the sealed container correspond to and engage the inside surface or surfaces of the hopper in a substantially parallel overlying relation to eliminate, or greatly reduce, the potential for exposing personnel or the environment to the contents being dispensed from the container. An intermediate pass-through region below the hopper is defined by a housing and includes an opening portion with an opening mechanism. The opening mechanism, operable from exterior the housing, has the opening components within the confines of the housing. In preferred embodiments, the opening mechanism has an opening head that punctures a sealed end of the instant container when the instant container is disposed in the hopper. The head is inserted into the container past end flaps and is then retracted outwardly opening the end by pulling the end flaps outwardly and downwardly allowing the flowable solid material to easily and fully discharge. The insertion and retraction of the opening head and the corresponding opening of the sealed end occurs entirely within the confines of the hopper thereby eliminating, or greatly reducing, the potential for exposing personnel or the environment to the contents being dispensed therefrom. The container may be initially secured in the hopper

It is therefore an object of preferred embodiments of this invention, to provide a sealed container for storing and dispensing a material disposed therein. The sealed container of this invention may include at least a first pair of opposed, tapering sides, the sides tapering toward a first end with a first end surface area, and a second end with a second end surface area opposite from the first end. The first end is openable when in the hopper. For example, a suitable container would be a cardboard box formed in a frustopyramidal shape with parallel planar ends with end surfaces. Due to the pyramidal shape a first end surface area will be less than the second end surface area and the cross-sectional interior area of the interior of the box decreases as the first end is approached. The first end may include a first end sealed structure, which may provide an egress for the material, when the material is being dispensed from the sealed container. The sealed container may further include a second pair of opposed tapering sides. The sealed structure may include generally triangular extensions from each of the tapering sides for closing the first end and the triangular extensions may be in a generally abutting relationship when in a closed, sealing position. The sealed structure may be further sealed by a sealant, such as tape. The sealed structure may also include a generally rectangular extension extending from each of the tapering sides. The rectangular extensions may cooperate to close the second end and include a venting aperture and a venting structure. The venting structure may be defined by perforations allowing manual opening of a vent. The container is preferably a box formed of corrugated cardboard material with a frustopyramidal shape. The box has a planar upper end, a planar lower end and preferably a plurality of planar sides. The box having a height that is preferably greater that a width of the box. Preferably, the lower end of the box placed in the hopper has a reduced area compared to the opposite upper end of the box and the cross-sectional area. The box is preferably formed with lower end flaps on the lower end that after puncturing the sealed end, insertion and retraction of the head opener, the flaps extend downwardly facilitating free flow gravitational dispensing of the material in the box. In a preferred embodiments the flaps are not overlapping and are triangular or trapezoidal facilitating wide opening of the lower end of the box by the opening mechanism.

A further object of preferred embodiments of this invention is to provide a dispenser for dispensing a generally flowable dry material from a sealed end of a container, the container having at least one pair of generally tapering sides. The dispenser may include a hopper and housing attached thereto, the housing defining a material pass-through region with an opening assembly positioned therein. When the box is in register with the hopper, the sides of the box are in overlying relationship with the inner surfaces of the hopper. Alternatively, there may be spacers between the sides of the box and the inner surfaces of the hopper and optionally, there may be a lip attached to the outer surfaces of the sides which lip is substantially parallel to the first end surface and which lip sealably engages the opening of the hopper. The hopper preferably accommodates the generally tapering sides of the dispenser in a generally parallel, contacting relation creating an effective seal between outer surfaces of the box and the inner facing surfaces of the hopper. The tapered sides define a decreasing interior cross-sectional area of the hopper in a downward direction. The pass-through region having a cross-sectional area generally not greater the cross-sectional area at a lower end of the hopper. The opening assembly may be disposed proximate, e.g., below, the hopper in the pass-through region and preferably includes an opener for puncturing and opening a sealed end of the container. The dispenser may further include a handle and a shaft, the shaft operatively attached to the handle to raise and lower the shaft. A piercing or puncturing opener head is disposed at the top of the shaft. The opener head is inserted into and retracted from the sealed end of the container by depressing and raising the handle. The dispenser may further include a conveyancing system operably disposed below the pass-through region proximate the opening assembly. The conveyancing system may convey the dispensed material from the dispenser and may include an auger or a fluid induction system.

Another object of preferred embodiments of this invention is to provide a method of mixing a dry flowable first material with a second material. The first material may be disposed in a sealed container having a pair of tapering, generally opposed sides. The method may include the steps of disposing the container in an open tophopper of a dispenser such that the pair of tapering, generally opposed sides of the container are in a contacting, generally parallel overlying relation to the inside surfaces of the hopper, such defined and confined area below the sealed container and within the dispenser; opening one end of the sealed container with an opener, the opener disposed in the dispenser below the hopper whereby the flowable material exits the container into and through the confined area. Opening the end of the container may be effected by the opener having opener head with a pointed tip and a flared tail portion, the tip contacting and puncturing the end of the container; inserting the head into the box where the tail portion enters into the container and then withdrawing the head from, the end of the sealed container whereby the tail portion catches and pulls the flaps of the end outwardly effectively opening the end of the container; flowing the first material out of the container; and mixing the first material with the second material. The first material may be mixed with a liquid to form a slurry. The foregoing method may further include conveying the first material from the dispenser to a mixer, in which the first material is mixed with the second material or with seed to thereby treat the seed. The first material may be conveyed from the dispenser by an auger or a fluid induction system. A fluid induction system may advantageously provide a slight suction effect that minimizes escape of dust or particles when the emptied box is removed from the hopper.

Yet another object of preferred embodiments of this invention is to provide a method of filling, storing and transporting a dry flowable material into containers. The containers are structured as described above. The box configuration facilitates palletizing multiple boxes and handling. The method may include closing and sealing one end in a closed-sealed position; flowing the material into the container; and sealing the other end in a closed-sealed position. The sealing of the end to be placed in the hopper is preferably accomplished by non-stretchable tape that is readily punctured and torn or split by the pointed opening head poking into the tape and end of the container.

It is an advantage and feature of one embodiment of the container of this invention to have tapered sides that conform and correspond to the tapering inside surfaces of the hopper

It is an advantage of the foregoing feature tapered sides will facilitate total evacuation and/or egress of the material stored therein when the material is being dispensed. Moreover, the tapered sides of the container in combination with the hopper form an effective seal to prevent the material being dispensed from escaping the container and dispenser. It is an advantage of the foregoing feature that the container can be easily and efficiently filled with the flowable dry material, then sealed for storage, transport, and use with the dispenser of this invention.

It is another advantage of the foregoing feature that the container can be easily and efficiently opened when disposed in a hopper of the instant dispenser, the opening accomplished in a closed area such that any dispersal or spillage of the dry flowable material is minimized.

It is yet another advantage of the foregoing feature that opening the container when the container is disposed in the present hopper eliminates, or greatly minimizes, exposure of personnel and the environment to the materials within the present container.

It is still another feature of the container of this invention to provide a venting structure.

It is an advantage of the foregoing feature that the venting structure allows materials stored within to be safely and efficiently dispensed from the container by being vented.

It is yet still another feature of one embodiment of the present container that the sealed structure includes a generally triangular extension from each side of the container, the generally triangular extensions in a substantially abutting relation when in a closed position.

It is an advantage of the foregoing feature that the container is more securely sealed due to the substantially abutting relation of the triangular extensions, the end flaps.

It is another advantage of the foregoing feature that the container is more easily opened by an opening mechanism, when the container is disposed in the dispenser of this invention.

It is a feature of one embodiment of the dispenser of this invention to include a hopper configured to provide a contacting, generally parallel relation to the sides of the instant container, when the instant container is disposed in the hopper.

It is an advantage of the foregoing feature that the contacting, generally parallel relation of the sides of the instant container and the hopper minimizes the likelihood of personnel or the environment being exposed to materials from the present container.

It is another advantage of the foregoing feature that the instant container is quickly and easily disposed in the hopper before the contents of the instant container are dispensed and before the container is opened.

It is yet another advantage of the foregoing feature that the instant container is securely held in the hopper when the contents thereof are being dispensed.

It is another feature of one embodiment of the instant dispenser to have an opening mechanism disposed proximate the hopper thereof.

It is an advantage of the foregoing feature that the opening mechanism opens the present sealed container when the present sealed container is securely disposed within the instant hopper, thereby eliminating, or greatly minimizing, the likelihood of personnel or the environment being exposed to the contents of the sealed container.

It is yet another feature of one embodiment of the instant dispenser to include a conveyancing system for the dispensed dry flowable material.

It is an advantage of the foregoing feature that the conveyancing system safely and efficiently conveys the material being dispensed from the instant container to a desired site remote from the present dispenser.

It is an advantage and feature of preferred embodiments that a piercing opening head first punctures with a pointed tip the first end of the sealed container, next pushes the end flaps inwardly as the opener in inserted into the container, the flaps retract back toward their original position as the opening head passes past the flaps, and then the tail portion of the head catches the end flaps and pulls the flaps outwardly to an outwardly extended position facilitating full flow of the dry flowable material into the dispensing portion of the system.

The objects and advantages of the invention are met in whole or in part by the present invention. These and other objects, features, and advantages of this invention will become apparent from the description which follows, when considered in view of the accompanying drawings.

### BRIEF DESCRIPTION OF THE DRAWINGS

FIG. 1 is a cross sectional view of one embodiment of the sealed container operably disposed in the dispenser of this invention;

FIG. 2 is a perspective view of the sealed container and the dispenser of FIG. 1;

FIG. 3 is a perspective view of the sealed container of FIG. 1;

FIG. 4 is a plan view of the container of FIG. 1 before being assembled;

FIG. 5 is a cross sectional view of one embodiment of the material from which the container of FIG. 1 is constructed;

FIG. 6a is a plan view of the container of FIG. 1, in which the sealed structure at a first end of the container is in a closed position;

FIG. 6b is a plan view of the container of FIG. 1, in which the sealed structure at the first end of the container is in a closed position and is sealed with a sealant tape;

FIG. 7a is a plan view of the container of FIG. 1, in which two of the extensions of the sealing structure are in a closed, generally abutting position;

FIG. 7b is a plan view of the container of FIG. 1, in which all of the extensions of the sealing structure are in a closed, generally abutting position;

FIG. 8a is a perspective view of another embodiment of a container;

FIG. 8b is a perspective view of a further embodiment of a container in accord with the invention herein;

FIG. 9 is a perspective view showing containers according to an embodiment of the invention stacked on a pallet;

FIG. 10 is a perspective view of the hopper of the dispenser of FIG. 1;

FIG. 11 is a cross sectional view of a hopper, pass-through portion and opening mechanism of the invention;

FIG. 12 is a perspective view of the present sealed container operably disposed in the a dispenser with a fluid induction conveyance system and a mixing system;

FIG. 13 is an elevational view of another embodiment of the present dispensing system.

FIG. 14 is a cross-sectional view of the embodiment of FIG. 13;

FIG. 15 is a plan view of the container of FIG. 15 is a closed configuration.

FIG. 16 is a perspective view of a first end of an alternate container;

FIG. 17 is a perspective view of the end of the container of FIG. 16 with the end flaps in a closed position;

FIG. 18 is a plan view of the opener head;

FIG. 19 is a cross-sectional view of the opener head of FIG. 18;

FIG. 20 is a elevational view of an alternative opener head;

FIG. 21 is a top plan view of the opener head of FIG. 20.

It is understood that the above-described figures are only illustrative of the present invention and are not contemplated to limit the scope thereof.

### DETAILED DESCRIPTION

Unless otherwise defined, terms used herein have the same meaning as commonly understood by one of ordinary skill in the art to which this invention belongs. In case of conflict, the present specification will control. In addition, the materials, methods, and examples are illustrative only and not intended to be limiting. Although methods and materials similar or equivalent to those described herein can be used to practice the invention, suitable methods and materials are described below.

Any references to such relative terms as inner and outer, upper and lower, or the like, are intended for convenience of description and are not intended to limit the present invention or its components to any one positional or spatial orientation. All dimensions and angles of the components depicted in the attached figures may vary with a potential design and the intended use of an embodiment of the invention without departing from the scope of the invention. “Substantially” when used herein also includes exactly the amount or characteristic that is referenced. When used herein, including the claims, “sealable container” or “sealable structure” can refer to a container or structure that is not yet sealed or that has been fully or partially sealed. “Sealed container” indicates a fully sealed container or can indicate a fully sealed container that has been opened in accordance with the invention herein.

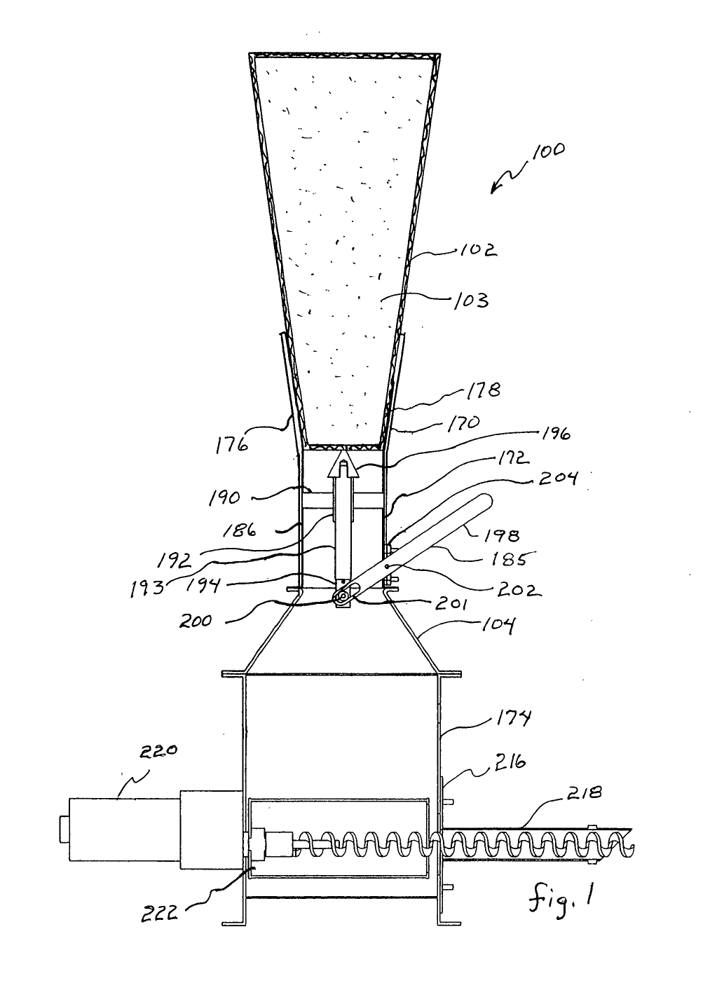

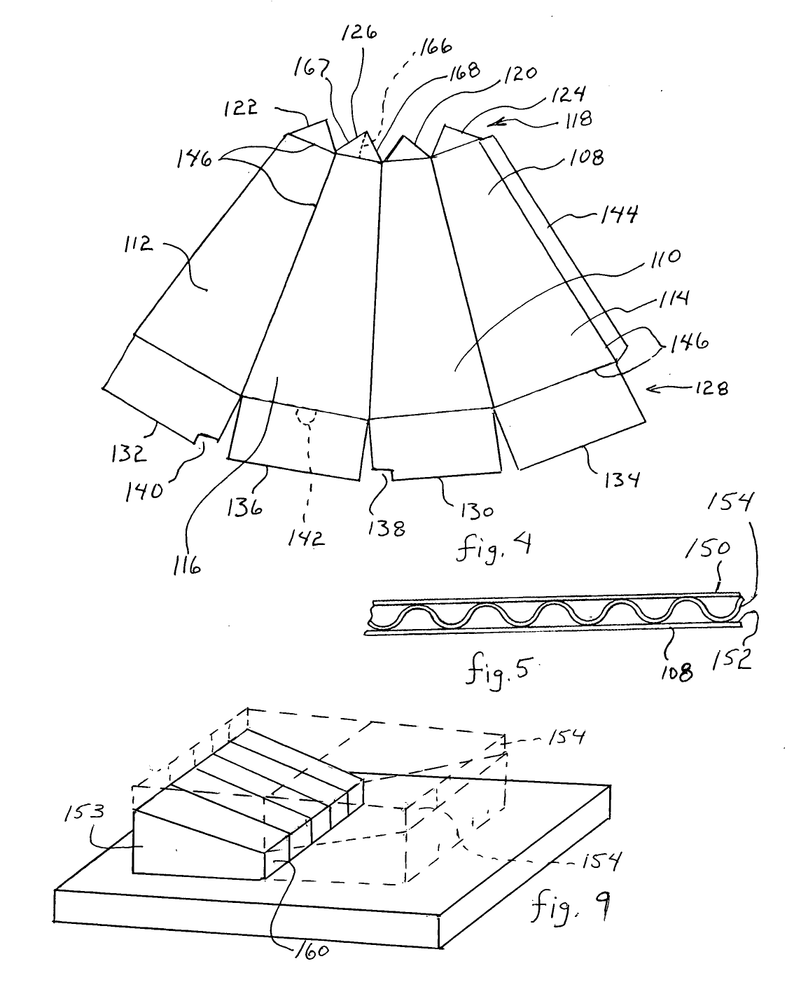

Referring to FIGS. 1-9, one embodiment of the present dispensing system is depicted generally at 100 and includes a sealable or sealed container 102 with a dry flowable material 103 therein and a dispenser 104. Referring particularly to FIG. 4, the container 102 may be made from a material 108 cut and creased to form at least one pair of opposed generally tapering sides 110 and 112. In the embodiment depicted, another pair of opposed generally tapering sides 114 and 116 are also present. The container 102 also includes one or more sealable or sealed structures. One sealable structure is indicated at 118 and includes generally triangular extensions 120, 122, 124, and 126 extending from respective sides 110, 112, 114, and 116. Another sealable structure is indicated at 128 and includes generally rectangular extensions 130, 132, 134, and 136, which extend from sides 110, 112, 114, and 116, respectively. In the embodiment shown, slots or notches 138 and 140 are defined within respective extensions 130 and 132 and a venting structure or air ingress aperture, e.g., a tab 142, is defined in the extension 136 by a perforation. Yet another sealable structure is indicated as an extension 144 from the side 116. The instant sides and extensions are formed by fold lines such as creases 146 in the embodiment depicted. However, the instant sides and extensions can be defined by other methods as well. Other methods suitable for defining the instant sides and extensions in some embodiments include “slit (cut) scoring” or “nick scoring” disclosed and described in U.S. Pat. No. 5,651,734, hereby incorporated by reference.

As shown in FIG. 5, one material 108 from which the present container is formed, and which may be biodegradable in some embodiments, is a corrugated board having liner layers 150 and 152 and a fluting layer 154 sandwiched between the liner layers 150 and 152. The corrugated board may be made from paper coated with a layer of clay, latex or some other substance not permeable to, or substantially altered by, the material so that the material can be safely stored and dispensed from the container 102. In other embodiments, the material 108 may be made from synthetic resins such as polyethylene. However, a person of ordinary skill in the art would readily select other suitable synthetic resins determined by the intended use from such documents as the Handbook of Plastics, Elastomers, and Composites, Third Edition, Charles A. Harper, Editor-in-Chief, McGraw-Hill, New York, N.Y. (1996), the entire disclosure of which is hereby incorporated by reference.

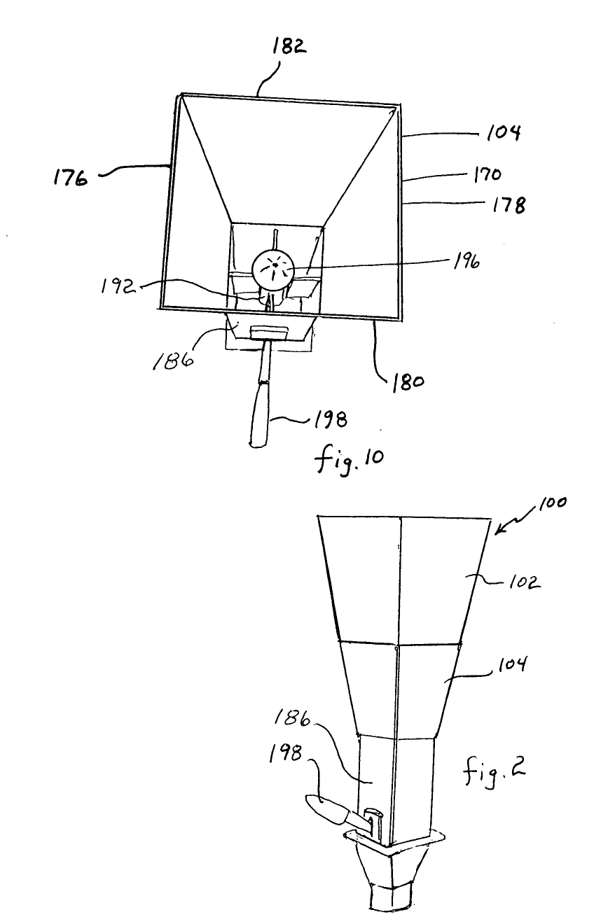

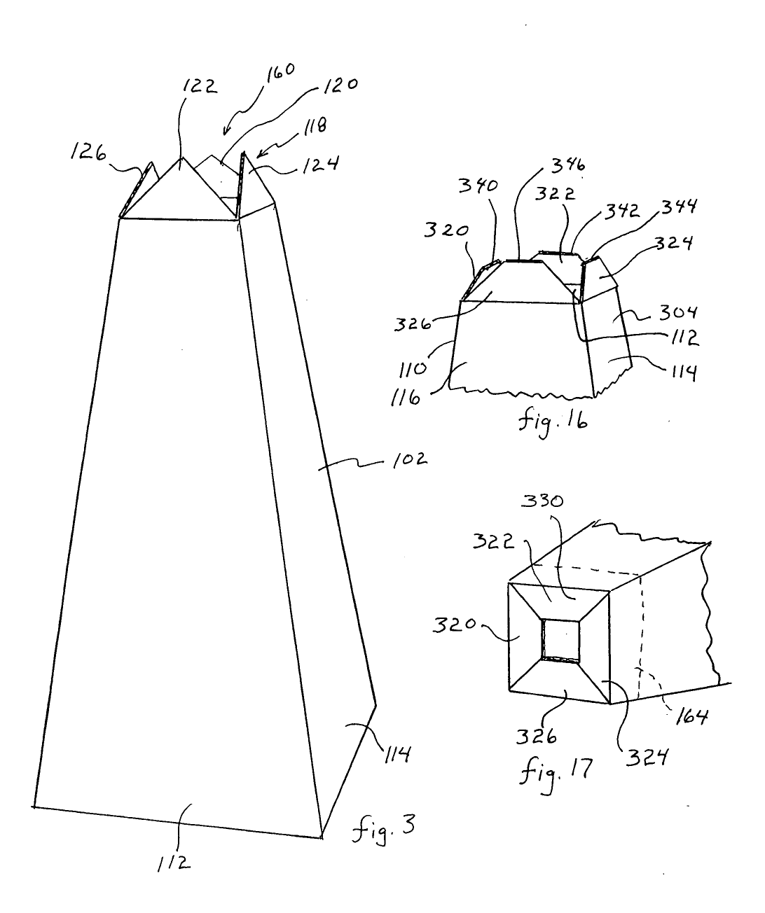

Referring specifically to FIGS. 3 and 4, the container 102 is prepared for assembly by attaching the extension 144 to an inside surface of the side 112 such that the side 112 appears to be contiguous with the side 114. In one embodiment, the extension 144 is attached to the inside surface of the side 112 by an adhesive. However, the extension 144 may also be attached to the side 112 by fasteners such as tape, staples, rivets, or the like.

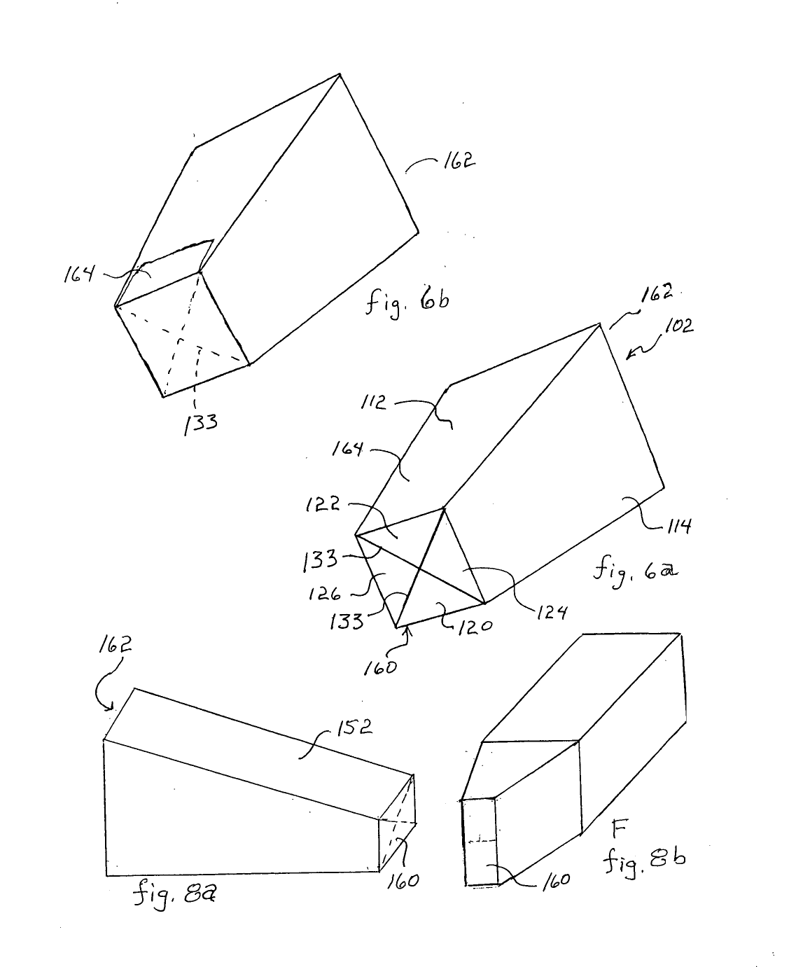

Referring now to FIGS. 6a and 6b, the discharge or first end 160 is closed by folding the material extensions 120, 122, 124, and 126 inwardly and sealing the closed extensions with a sheet material with adhesive backing such as tape 164. The sealant tape may preferably have a polymer, foil, or paper based substrate. The tape finctions to provide a seal of high integrity that easily and fully or substantially splits open when engaged with a piercing opener rather than stretching for example. In the embodiment depicted, the extensions 120, 122, 124, and 126 will generally abut each other when folded inwardly to better close the instant container. As seen in FIGS. 7a and 7b, the second end 162 is closed by first folding the extensions 130 and 132 inwardly so that they generally abut at junctures 133 and so that the slots 138 and 140 adjoin. Then the extensions 134 and 136 are folded inwardly and over the extensions 130 and 132 so as to abut. The folded extensions may be fixed in place, e.g., by using a layer of sealant material such as tape 164. In this closed position the tab 142 will overlay the slots 138 and 140. Some embodiments of the present sealed container may be used with a liner or bag (not shown) configured and dimensioned to be accommodated therewithin.

While the present sealed container is depicted as having four generally tapering sides providing a frustopyramidal shape, several shapes are contemplated, the shape of a specific embodiment being determined by such factors as the geometry of the hopper of the instant dispenser or by shipping and storing requirements. In one alternative embodiment, the present sealed container may have a single pair of opposed, generally sloping sides and another pair of generally parallel sides. In another embodiment, the present sealed container may have three generally tapering sides. In yet another embodiment, the sealed container of this invention may have a frustoconical shape. The box may be shaped as elongate frustoconical or elongate frustopyramidal section. The pyramid may be a trigonal or square pyramid or may be, e.g., a polygonal pyramid of n sides. That is, the first end surface forms a polygon of n sides, n being an integer from 3 to 12. Similarly, the configuration of structure closing the first end of the sealed container of this invention may include four generally triangular extensions (e.g., if the present sealed container has four sides) or a pair of generally opposed extensions similar to the pair of extensions 134 and 136. Still another embodiment of the instant structure closing the first end of the sealed container of this invention would be to have six extensions, each said extension defined when the extensions 120, 122, 124, and 126 are divided along a line extending from the triangular apex to the midpoint along the boundary with the container side. One such exemplary line is depicted in FIG. 4 at 166 and the extensions defined at 167 and 168. Another embodiment may have a continuous, that is, without flaps, end surface with is pierced by the piercing end opener. For example, a plastic sheet membrane exposed at the first sealable end with no cardboard or flap material.

In alternative configurations, the sealed container may have a rectangular box portion with an integral frustopyramidal portion as illustrated in FIG. 8b. Such a configuration would be conducive to stacking such as on a pallet and still effectively provide the funneling function by the container. Another readily stackable configuration of the sealed container is illustrated in FIG. 8a. In this configuration the first end 160 and second end 162 are parallel with respect to each other and perpendicular with three of the four sides. The fourth side 152 is inclined to form the taper and the convergence toward the first end. Referring to FIG. 9, this configuration is readily stacked on a pallet or the like. The bottommost layer 153 has two rows with the first smaller ends inwardly facing and abutting one another. The second layer 154 has the smaller first ends oriented outwardly whereby the top surface of the second layer forms a flat horizontal base for the next layer.

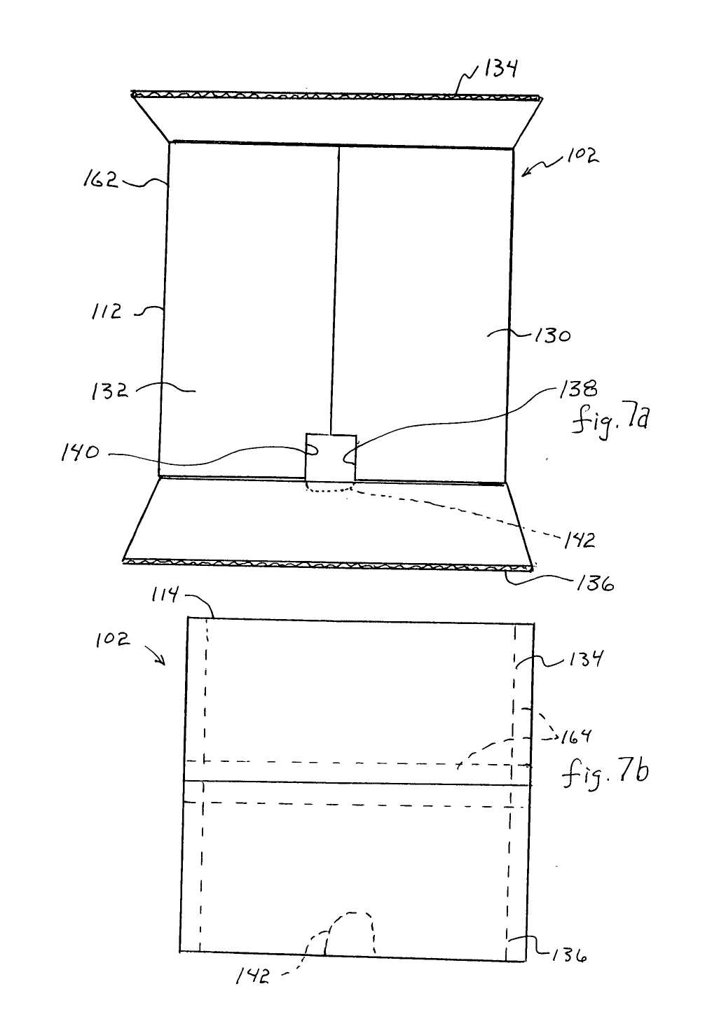

Referring to FIGS. 1, 2, 10, 11, and 12, the dispenser 100 includes a hopper 170, an opening portion 172, and a dispensing portion 174. The hopper 170 is shaped to accommodate the sides of present sealed container in a substantially parallel contacting overlying relation. For example, if the present sealed container has two pairs of generally tapering sides as described above, the hopper 170 will have two pairs of generally tapering sides as well. In the embodiment depicted, the hopper 170 has sides 176, 178, 180, and 182 (FIG. 10).

The opening portion 172 includes an opening mechanism 185, a housing 186, which may join a funnel 188. The funnel 188, in turn, delivers the material being dispensed into the dispensing portion 174. Also included in the opening assembly 172 is a bracket 190 attached to a sleeve 192 and to sides of the housing 186. The sleeve 192 accommodates a shaft 193 therewithin, the shaft 194 terminating in an opener 196. In the embodiment depicted, the opener 196 may be conical. One end of a handle 198 is attached to a lower end 194 of the shaft 193 by a connector 200 disposed within a slot 201. The handle 198 is also attached by a pivot 202 to a bracket 204. Moving the handle 198 downwardly in the direction indicated by the arrow 206 will displace the opener 196 upwardly in the direction of the arrow 208 along the axis of the shaft and opener. Moving the handle 198 in the opposite direction will return the opener 196 to the position shown in FIGS. 1, 11a, and 11b. Other mechanisms suitable for use in displacing the opener 196 as shown and described include solenoids or linear motors. While the present opener is described as being generally conical, several geometries may be suitable, e.g., prismatic with a pointed corner oriented upwardly, or shaped as a broadhead arrowhead with a plurality of cutting blades. In certain embodiments the opener can engage and pierce the sealed end when the sealed container is placed in the hopper. With specific sealed end configuration, the opener may be fixed such that the sealed end is sufficiently opened that the opening mechanism is not needed. The specific geometry of the present opener is not critical if the present opener performs the opening finction described below.

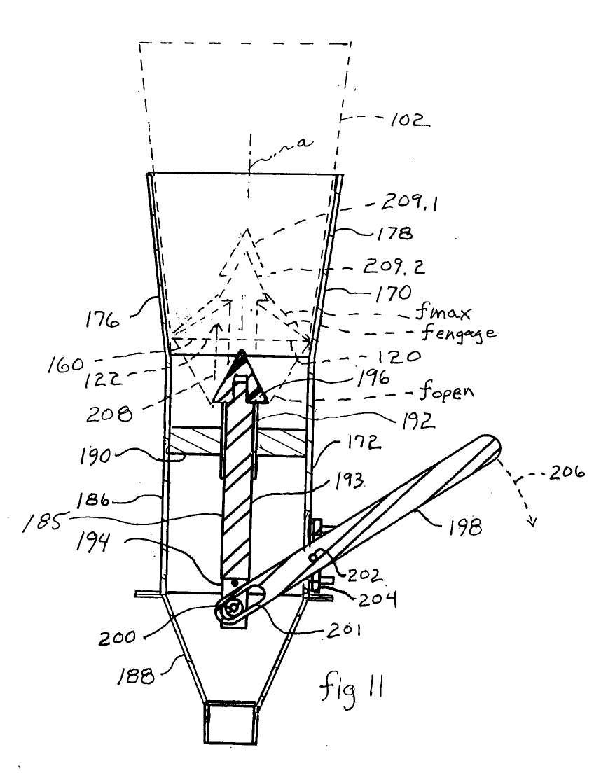

The dispensing portion 174 as depicted in FIG. 1 has a housing 216, which houses an intake portion of a conveyancing system such as an auger 218 driven by a motor 220. The intake portion of the auger 218 disposed within the housing 216 is disposed proximate a trough 222. The trough 222 gathers the materials being dispensed toward the auger 218. In lieu of an auger, the present dispensing assembly can include in induction unit using pressurized fluid to convey the materials being dispensed. One embodiment using fluid under pressure is depicted in FIG. 12, in which a fluid induction system 226 delivers pressurized fluid from a pump 227 via a hose 228 to a mixing chamber 230. At the mixing chamber 230 the material being dispensed is drawn from the dispenser 104 into the fluid stream and conveyed through a hose 232 to a mixing container 234. The fluid being mixed may be recirulated through the pump 227. Obviously, a person of ordinary skill in the art could readily use other conveyancing systems than the auger or fluid induction system to convey dispensed materials in other embodiments. Moreover, the present dispensing system may be operably mounted directly above where the materials being dispensed are to be conveyed in some embodiments so that a conveyancing system is not necessary. The foregoing conveyancing systems may be used to meter desired quantities of the material being dispensed from the instant container. However, the materials may also be dispensed in quantities without being metered if desired.

Another embodiment of the container of the present invention is depicted in FIGS. 16 and 17 and includes a box 302 suitably made from of the same as materials as the container 102 and differs therefrom at a first end 330 by a sealable structure, with extensions 320, 322, 324, and 326, which extend from respective sides 110, 112, 114, and 116. Rather than terminating in a pointed tip, the extensions 320, 322, 324, and 326 terminate in blunted ends 340, 342, 344, and 346, respectively, to present a generally trapezoidal geometry. The first end 330 of the container 302 is shown in a generally open position in FIG. 16 and in a closed position in FIG. 17. When in the closed position, the extensions 320, 322, 324, and 326 are in a generally contacting relationship and define an opening 350 (e.g., about 1 inch square in dimension) bounded by the blunted ends 340, 342, 344, and 346. As with the container 102, the first end 330 may be sealed by using a layer of sealing material 164 such as packaging tape or equivalent methods. One advantage of the first end 330 of the dispenser 304 is that it may be opened more easily and inefficiently by the opener 196 or another opener described below. One reason the dispenser 304 is more easily and efficiently opened is that the opening 350 may more readily punctured and admit the tip of the present opener when the present container is being opened. In another embodiment, the flaps may be excluded entirely.

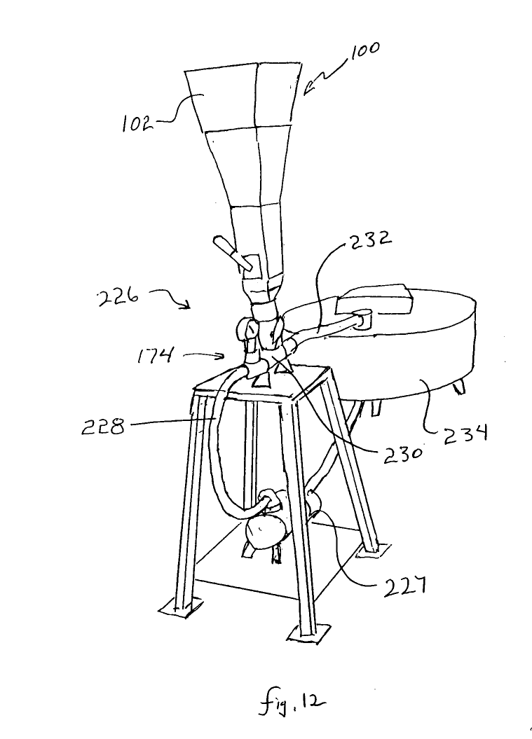

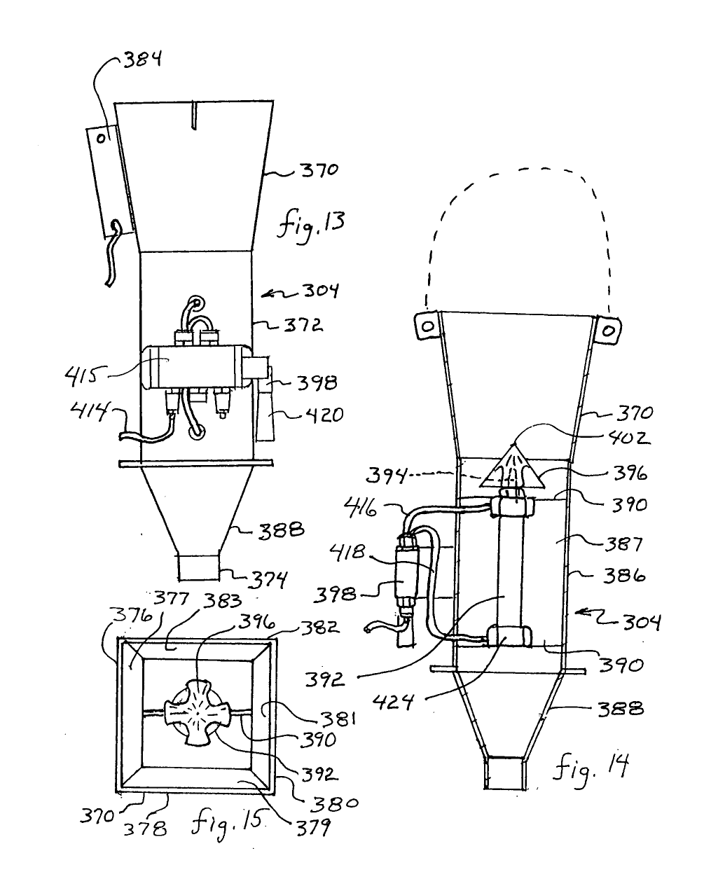

Referring to FIGS. 13, 14, and 15, a further embodiment of the dispenser 304 is illustrated and includes a hopper 370, an opening portion 372, and a dispensing portion 374. The hopper 370, in turn, has sides 376, 378, 380, and 382 with inside and inwardly facing surfaces 377, 379, 381, and 383 that are configured and dimensioned to establish and maintain a generally parallel contacting and overlying relation with the sides of the container is inserted for dispensing the contents thereof. In some embodiments, a facilitating device such as a vibrator 384 may be present. If present, the vibrator 384 enables the contents to be more uniformly dispensed by preventing the contents thereof and from being packed or bridged. In the embodiment depicted, the vibrator 384 is pneumatically powered. However, manually operated vibrators, or those powered by electricity or the like may be used with other embodiments.

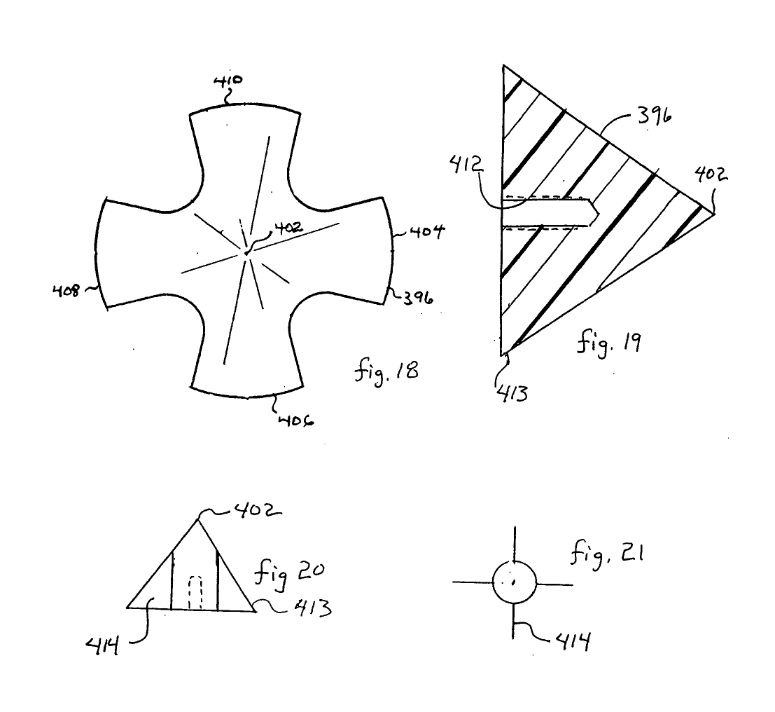

The opening portion 372 has a housing 386 defining a pass-through region 387 which adjoins a funnel 388. A bracket assembly 390 may be attached to interior surfaces of the housing 386 to support a pneumatic cylinder 392. The pneumatic cylinder 392, in turn, accommodates a shaft 394. The shaft 394 terminates in an opener 396. The shaft 394 and the opener 396 may be operated by an actuator 398. Referring to FIGS. 18 and 19, the opener 396 is arrow shaped and conically terminates at a point 402 and at a plurality of, e.g., four generally symmetrical, basal extensions 404, 406, 408, and 410. A threaded bore 412 may be used to attach the opener head with the shaft 396. Another embodiment is illustrated in FIGS. 20 and 21 where the opener head may have cutting blades 414 associated therewith. In embodiments where the opener has blades, the blades may preferably be aligned with the junctures 133, as illustrated in FIGS. 6a and 6b, to facilitate the splitting and tearing of the layer of sealing material. Other anticipated embodiments include “active” heads where the basal portions are extendable laterally after the head enters the lower end of the container and/or partially rotate to facilitate more complete opening of the end flaps.

As an alternative to the manually-operated opening mechanism disclosed with respect to the dispenser 100, the actuator 398 may be pneumatically powered as is illustrated. Referring to FIGS. 13 and 14, compressed air (or a partial vacuum) is communicated to a control mechanism 415 by a tube 414. The compressed air (or partial vacuum) is conveyed away from the control mechanism 415 by one of the tubes 416 or 418, depending upon the position of a handle 420. When the handle 420 is raised or otherwise actuated, the opener 396 is thrust upwardly by a pneumatic cylinder 392 to penetrate the first end 330 of the container 302. When the handle 420 returns to the position depicted in FIG. 13, the opener 396, having penetrated the closed container 302, is pulled downwardly thereby forcing the extensions 320-326 apart and opening the container 302 as illustrated in FIG. 11 and described in the text associated with that figure. The opener extensions 404, 406, 408, 410 are configured to confront, and force open, the container extensions 320, 322, 324, 326. The actuator 398 may be configured to provide the insertion and retraction with a single depression or actuation.

In other embodiment, the actuator may an electric solenoid or linear motor or may by hydraulically operated.

Other embodiments may have an automatic actuation of the opening mechanism, for example when the container is properly seated or when the securement or anchoring mechanism is in position.

The dispenser 304 may be any of the dispensers discussed with respect to the dispensing system 100.

In use, either the first or second end of the present container is closed and sealed as described above, the present container is then filled with a material to be dispensed, and the other of the first or second end is then closed and sealed as also described above. To be dispensed from the instant sealed container, the container is disposed within the hopper (as shown in FIG. 2) such that the sides of the hopper contact the sides of the instant container. To vent the container as the materials within are dispensed therefrom, the tab 142 is separated from the remainder of the extension 136 by cutting the perforation therearound.

Referring specifically to FIG. 11, the sealable container 102 with the first end 160 is indicated by dashed lines. When the sealable container is placed in the hopper the piercing opener is below the first end in the retracted position. When the opening mechanism is actuated the opener 196 engages and pierces the first end. As the opener continues upwardly, to the extended position shown at the position labeled 209.1 the end flaps 120, 122 have been pushed inwardly a maximum amount as indicated by “fmax”. The opener, including the tail section, extends past the flaps and the flaps flip back downwardly to the “fengage” position. The opener retracts to engage the flaps and to pull the flap downwardly and outwardly to the “fopen” position. From the dispensing assembly, the material is conveyed to a desired location by means of the auger 218, the air induction system 226, or by an equivalent conveyancing system. In some embodiments, a mechanism imparting mechanical vibrations may be suitable so as to insure that the material being dispensed will flow readily from the instant container.

The materials stored in the instant sealed container and dispensed by the present dispensing system may be flowable solids, such as granules, powders, tablets, and the like. By way of illustration and not limitation, flowable solids may include fungicides, bactericides, herbicides, plant growth hormones, animal feed additives, human feed additives, and fertilizer ingredients. While the instant sealed container is described in the context of being utilized for dispensing materials by the present dispenser, the instant sealed container may be utilized solely for efficiently storing and transporting quantities of flowable materials. Because the instant sealable and then sealed container is easily assembled, filled, transported, stored, and opened, it is contemplated for any of the foregoing uses when handling quantities of flowable solids.

One use of the instant dispensing system is to meter, or otherwise dispense, flowable solids from the present sealed container to a mixer to generate a slurry, the slurry later used for treating seeds with fungicides and/or insecticides. Another use of the instant dispensing system is to meter, or otherwise dispense, flowable solids from the present sealed container to a mixer to makes desired amounts of the dispensed flowable solids with other solid materials. Yet another use of the instant dispensing system is to meter, or otherwise dispense, flowable solids from the present sealed container to a treating device, e.g., continuous flow, batch, for treating seeds therein. Other uses for the present dispensing system include dispensing, or metering, flowable solids when products such as animal feeds, human foodstuffs, concrete, and fertilizers are being mixed or formulated.

Other aspects of the invention include a box for carrying a dry flowable seed treatment material, the box having a first end and an opposite second end, the box shaped to be narrowing from the second end to the first end. Additionally, an aspect is a box that has flaps on a first end to be deposited in a hopper, the first end having a plurality of flaps with the edges of the flaps all coplanar whereby the flaps do not overlap. Further, the flaps are secured together with a tape like material that has a tendency to split rather than stretch. Preferably the above boxes are corrugated cardboard. In another alternative embodiment the container may be a frustoconical shape.

Other aspects include the system where the box containing the flowable dry material seals with the hopper and the opening mechanism being contained within the housing associated with the hopper. The invention includes aspects such that the sealable container will not need the tapering sides and conventionally shaped boxes may be used.

Because numerous modifications of this invention may be made without departing from the spirit thereof, the scope of the invention is not to be limited to the embodiments illustrated and described. Rather, the scope of the invention is to be determined by the appended claims and their equivalents.

1. A combination sealable container for storing and dispensing dry material contained therein and such dry material, the sealable container configured as a box and comprising a substantially flat first end and an opposite second end with a plurality of substantially flat sides extending between said first and second ends, the sides providing a convergence to the first end, the first end comprising a first end sealed structure comprising a plurality of end flaps and a layer of sealing material extending over said end flaps, the layer of sealing material tearable by insertion of a pointed opener into the first end whereby when the layer of sealing material is torn, the plurality of end flaps are extendable outwardly thereby providing an egress for dispensing the material.

2. The combination of claim 1 wherein the layer of sealing material comprises a plastic sheet material having a tendency to tear rather that stretch when poked under tension with a pointed opener.

3. The combination of claim 1 wherein the dry material is comprises a pesticide.

4. The combination of claim 1 whereby when the first end of the sealable container is sealed, the plurality of end flaps are substantially in planar alignment with each other and are not overlapping each other.

5. The combination of claim 4 wherein the end flaps of the sealable container comprise generally triangular extensions from each of sides of the container.

6. The combination of claim 1 whereby when the second end of the sealable container is sealed said end is substantially flat and parallel to the first end when first end is sealed.

7. The combination of claim 1 whereby when the second end of the sealable container has an openable vent defined by perforations in said second end.

8. A combination sealable container and dry flowable material contained within said container, the container having a frustopyramidal shape and the flowable material is selected from the group comprising: pesticides, plant growth regulators, herbicide safeners, and bactericides.

9. A dispenser for dispensing a generally flowable solid material from a sealed end of a container, the container having sides converging to the sealed end, the dispenser comprising:
a hopper having converging sides shaped to sealingly conform to said sides converging to the sealed end of the container; and
an opening portion disposed below the hopper and comprising an opener with an opener head with a pointed end for puncturing and opening the sealed end of the container, the opener moveable upwardly for insertion into and retraction from the sealed end of the container when the container is in place in the hopper.

10. The dispenser of claim 9, in which the opener is generally cone-shaped.

11. The dispenser of claim 9, further comprising a handle and a shaft, the shaft pivotally attached to the handle and terminating in the opener head and in which the opener head is insertable into the sealed end of the container by pivoting the handle.

12. The dispenser of claim 9, further comprising a conveyancing system operably disposed below the opening portion, the conveyancing system for conveying the dispensed material from said dispenser.

13. The dispenser of claim 12, in which the conveyancing system comprises an auger or a fluid induction system.

14. A dispenser in combination with a plurality of boxes filled with dry flowable material, the dispenser comprising a hopper with interior surface having converging configuration, the boxes each having a converging exterior and being configured with a shape precisely conforming to the converging configuration of the hopper whereby when one of said boxes is placed in said hopper, a seal is formed between said one of said boxes and the interior surface having a converging configuration.

15. The dispenser in combination with the plurality of boxes filled with dry flowable material of claim 14, wherein said dry flowable material is selected from the group comprising: pesticides, plant growth regulators, herbicide safeners, and bactericides.

16. The dispenser in combination with the plurality of boxes filled with dry flowable material of claim 14, wherein the boxes are frustopyramidal in shape.

17. The dispenser in combination with the plurality of boxes filled with dry flowable material of claim 14, wherein the converging exterior converges to a first end, and wherein the first end comprising a first end sealed structure comprising a plurality of end flaps and a layer of sealing material extending over said end flaps.

18. A method of containing a solid flowable material, the method comprising the steps of:
configuring a box from cardboard having a plurality of tapering sides wherein each side has an associated end flap at a first end for forming a first sealed end;
putting flowable material into the box;
configuring and folding each end flap to close at said first end so that none of the end flaps overlap any of the other end flaps; and
covering the folded end flaps with a layer of sealing material thereby sealing said first end.

19. The method of claim 17 further comprising the step of coating the cardboard.

20. The method of claim 17 further comprising the step of selecting a pesticide for the dry flowable material.

21. The method of claim 18, further comprising the step of forming a second sealed end opposite from the first, said second sealed end having venting structure.

22. A method of dispensing a generally flowable solid material from a sealed container, the sealed container having at least two generally tapering sides converging to a sealed first end, the method comprising the steps of:
disposing the sealed container in a hopper of a dispenser with the sealed first end downwardly facing and contained entirely within the hopper;
providing a seal between an inside surface of the hopper and the sealed container to prevent escape of the flowable solid material during dispensing;
opening the first sealed end of the sealed container with a mechanical opener by moving the mechanical opener upwardly puncturing said first sealed end.

23. The method of dispensing generally flowable solid material from a sealed container of claim 22 wherein the mechanical opener comprises a opener head with a pointed end and a tail section and wherein the method further comprises the step of inserting the opener head entirely into the sealed container.

24. The method of dispensing generally flowable solid material from a sealed container of claim 23 wherein the mechanical opener comprises a opener head with a pointed end and a tail section and wherein the method further comprises the step of inserting the opener head entirely into the sealed container.

25. The method of dispensing generally flowable solid material from a sealed container of claim 24 wherein the first sealed end comprises end flaps and wherein the method further comprises the step of retraction of the opener head from the sealed container whereby the end flaps are pulled to extend outwardly from said sealed container and the flowable material flows out of said opened first sealed end.

26. The method of dispensing generally flowable solid material from a sealed container of claim 22 wherein the first sealed end comprises a layer of sealing material extending thereacross and wherein the puncturing of said first sealed end comprises a tearing of the sealing material.

27. The method of dispensing generally flowable solid material from a sealed container of claim 22 wherein the first sealed end comprises a layer of sealing material extending across a plurality of end flaps and wherein the puncturing of said first sealed end comprises a tearing of the sealing material but not a tearing of the end flaps.

28. The method of dispensing generally flowable solid material from a sealed container of claim 22 further comprising the step of conforming the exterior shape of the sealed container to precisely overly the interior surfaces of the hopper thereby providing the seal between an inside surfaces of the hopper and the sealed container.

29. The method of dispensing generally flowable solid material from a sealed container of claim 22 further comprising the step conveying the material away from the dispenser.

30. The method of dispensing generally flowable solid material from a sealed container of claim 22 further comprising the step of conveying the material away from the dispenser by one of either an auger or an fluid induction system.

31. The method of dispensing generally flowable solid material from a sealed container of claim 22 further comprising the step of providing a vent in the top of the sealed container to facilitate the egress of the material therefrom.

32. A method of dispensing a generally flowable solid material from a sealed container, the method comprising the steps of:
disposing the sealed container in a hopper of a dispenser with the sealed first end downwardly facing and contained entirely within the hopper;
providing a seal between an inside surface of the hopper and the sealed container to prevent escape of the flowable solid material during dispensing;
opening the first sealed end of the sealed container with a mechanical opener by moving the mechanical opener upwardly into said first sealed end and retracting the mechanical opener.

33. The method of dispensing generally flowable solid material from a sealed container of claim 32 further comprising the step of conforming the exterior shape of the sealed container to precisely overlie the interior surfaces of the hopper thereby providing the seal between an inside surfaces of the hopper and the sealed container.

34. The method of dispensing generally flowable solid material from a sealed container of claim 33 wherein the first sealed end comprises a layer of sealing material extending across a plurality of folded end flaps and wherein opening of said first sealed end comprises a tearing of the sealing material but not a tearing of the end flaps.

35. A method of dispensing a generally flowable solid material into a hopper with minimal escape of the flowable solid material, the hopper having interior converging surfaces, the method comprising the steps of:
packaging the flowable solid material into boxes having converging sides that converge to a sealed end, the converging sides configured to precisely conform to the shape of the interior converging surfaces of the hopper;
providing a mechanical opener contained within a housing below the hopper;
positioning one of the sealable container of the flowable solid material into the hopper thereby forming a seal between the interior converging surfaces of the hopper and the box;
operating the mechanical opener container within the housing to open the sealed end of the box to discharge the dry flowable material out of the box.

36. The method of dispensing generally flowable solid material into a hopper of claim 35 wherein the sealed end comprises a layer of sealing material extending across a plurality of folded end flaps and wherein opening of said sealed end comprises a tearing of the sealing material but not a tearing of the end flaps.
